(19) United States
(12) Patent Application Publication
(10) Pub. No.: US 2024/0185712 A1
(43) Pub. Date: Jun. 6, 2024

(54) INFORMATION ANALYSIS DEVICE AND INFORMATION ANALYSIS METHOD

(71) Applicant: HONDA MOTOR CO., LTD., Tokyo (JP)

(72) Inventors: Masato OKUBO, Tokyo (JP); Eriko YAMAMOTO, Tokyo (JP); Kazune FURUDO, Tokyo (JP)

(21) Appl. No.: 18/527,380

(22) Filed: Dec. 4, 2023

(30) Foreign Application Priority Data
Dec. 5, 2022 (JP) 2022-194443

(51) Int. Cl. G08G 1/065; G01C 21/00

(52) U.S. Cl. CPC G08G 1/065; G01C 21/3863

(57) ABSTRACT

A change in usage mode of a facility is detected. An information analysis device (1) includes a visit pattern information creation section (112) which creates visit pattern information related to a facility from vehicle information from a plurality of vehicles and a transition in successive positional information, and creates visit vehicle information related to the facility by cumulating vehicles parked in a parking lot of the facility for every vehicle information; a visit pattern change determination section (113) which determines whether both a change amount after a predetermined time period of the visit pattern information and a change amount after a predetermined time period of the visit vehicle information have changed; and a facility change information creation section (114) which creates facility change information indicating a change in facility information.

This application is based on and claims the benefit of priority from Japanese Patent Application No. 2022-194443, filed on 5 Dec. 2022, the content of which is incorporated herein by reference.

### BACKGROUND OF THE INVENTION

### Field of the Invention

The present invention relates to an information analysis device and an information analysis method which detect a change in the usage mode of a facility, by generating visit pattern information to a facility based on positional information transition data of a vehicle acquired from a vehicle as vehicle travel information, and determining a change in visit pattern information to the facility.

### Related Art

Applications are broadening that receive FCD (Floating Car Data) including GPS positional information from a plurality of vehicles by a server, and use in data analysis related to facilities visited by vehicles, based on collected position information, etc. (for example, Patent Document 1). In addition, for example, applying to an application using as alternative data of investment purpose or the like can also be considered. However, in order to use as alternative data related to facilities, in the case of there being a change in the usage mode of the facility, it is necessary to configure so that the data related to this facility is not used. In this regard, for a map on which roads and buildings are published, technology is being developed to detect changes therein without relying on manpower, and to automatically correct. For example, Patent Document 2 discloses technology detecting a change in houses, buildings, etc. on a two-dimensional map using three-dimensional data created by inputting a plurality of images capturing predetermined regions from a plurality of different positions as map change detection device. However, in the technology disclosed in Patent Document 2, the change in facilities themselves can be detected; however, it is not possible to detect so far as a change in usage mode of facilities. Therefore, for example, changes in business form and usage mode of facilities such as a men's clothing store changing into an internet café, or a restaurant which was open all day and night cancelling their lunch service cannot be detected.

### CITATION LIST

### Patent Document

Patent Document 1: Japanese Unexamined Patent Application, Publication No. 2020-144587
Patent Document 2: Japanese Patent No. 4378571

### SUMMARY OF THE INVENTION

In order to enable visitor analysis to facilities by big data analysis of FCD acquired from vehicles, etc., an information analysis device and information analysis method which can easily detect changes in usage mode of facilities without relying on manpower has been demanded. The user can directly confirm the change contents in the usage mode of facilities, by field survey or the like, for example.

The present invention has been made taking account of such a problem, and has an object of providing an information analysis device and an information analysis method which can detect a change in business form or usage mode of a facility without relying on manpower, by generating visit pattern information as visit pattern information to a facility and visit vehicle information, based on positional information transition data of the vehicle including vehicle information acquired from the vehicle as vehicle travel information, and determining a change in the visit pattern information and visit vehicle information.

An information analysis device (for example, the information analysis device 1 described later) according to a first aspect of the present invention includes:
a map information storage unit (for example, the map information storage section 121 described later) which stores map information including facility information indicating an attribute of a facility for a plurality of facilities and parking lot information of the facility linked to the facility;
a vehicle travel information storage unit (for example, the vehicle travel information storage section 122 described later) which stores a vehicle travel information table (for example, the vehicle travel information table 1221 described later) including at least vehicle information, departure positional information, date/time information of departing, parking positional information, date/time information of parking and parked hours of a plurality of vehicles, the departure positional information being positional information of a vehicle departing, the parking positional information being positional information of the vehicle in a case of there being no change for at least a predetermined time in the positional information of the vehicle;
a parking position recording unit (for example, the parking position recording unit 111 described later) which collects and stores the parking positional information included in the vehicle travel information table, the parking positional information corresponding to parking lot information of the facility;
a visit pattern information creation section (for example, the visit pattern information creation section 112 described later) which visit pattern information related to the facility based on positional information of the vehicle included in a vehicle travel information table of a plurality of vehicles parked in a parking lot of the facility collected by the parking position recording unit, and creates visit vehicle information related to the facility by cumulating vehicles parked in the parking lot of the facility for every vehicle information;
a visit pattern information storage section (for example, the visit pattern information storage section 123 described later) which stores the visit pattern information related to the facility and the visit vehicle information related to the facility by date/time and/or every day of the week;
a visit pattern change determination section (for example, the visit pattern change determination section 113 described later) which determines that both visit pattern information related to the facility stored in the visit pattern information storage section and visit vehicle information related to the facility have changed after a first predetermined time period set in advance; and a facility change information creation section (for example, the facility change information creation section 114 described later) which creates facility change information indicating a change in the facility information, when the visit pattern change determination section determines that both the visit pattern information and the visit vehicle information have changed.

According to the first aspect, it becomes possible to easily detect a change in the business form or usage mode of a facility without relying on man power, based on vehicle information and positional information transition data of vehicles acquired from vehicles as vehicle travel information.

According to a second aspect of the present invention, the information analysis device (for example, the information analysis device 1 described later) as described in the first aspect may further include:
a receiving unit (for example, the receiving unit 110A described later) which receives vehicle information indicating an attribute of a vehicle from a plurality of vehicles, and successive positional information of the vehicle as vehicle travel information together with time information; and
a vehicle travel information recording unit (for example, the vehicle travel information recording unit 110B described later) which creates a vehicle travel information table including at least vehicle information, departure positional information, date/time information of departing, parking positional information, date/time information of parking and parked hours of a plurality of vehicles, the departure positional information being positional information of a vehicle departing, the parking positional information being positional information of the vehicle in a case of there being no change for at least a predetermined time in the positional information of the vehicle.

According to the second aspect, the same effects as the information analysis device described in the first aspect are exerted.

According to a third aspect of the present invention, in the information analysis device (for example, the information analysis device 1 described later) as described in the first aspect, the visit pattern information creation section (for example, the visit pattern information creation section 112 described later) may be configured to create visit pattern information of the facility by cumulating a number of vehicles for every time slot in which parking of the vehicle was started, based on a vehicle travel information table of vehicles parked in a parking lot of the facility collected by the parking position recording unit.

According to the third aspect, the same effects as the information analysis device described in the first aspect are exerted.

According to a fourth aspect of the present invention, in the information analysis device (for example, the information analysis device 1 described later) as described in the first aspect, the visit pattern information creation section may be configured to create the visit pattern information (for example, the second visit pattern information described later) as summary value information of departure positional information for every grid cell, obtained by plotting and cumulating the departure positional information of the vehicle in every predetermined grid cell created in the map information, based on a vehicle travel information table of vehicles parked in a parking lot of the facility collected by the parking position recording unit.

According to the fourth aspect, the same effects as the information analysis device described in the first aspect are exerted.

According to a fifth aspect of the present invention, in the information analysis device (for example, the information analysis device 1 described later) as described in the first aspect,
the visit pattern information creation section may be configured to create visit pattern information (for example, the third visit pattern information described later) related to the facility by cumulating, for every time slot in which parking was started, parked hours of the vehicle parked at each of the parking lots based on a vehicle travel information table of the vehicle parked in a parking lot of the facility collected by the parking position recording unit.

According to the fifth aspect, the same effects as the information analysis device described in the first aspect are exerted.

According to a sixth aspect of the present invention, in the information analysis device (for example, the information analysis device 1 described later) as described in any one of the first to fifth aspects, the vehicle information may be configured to include any information of a vehicle model or vehicle type of the vehicle.

According to the sixth aspect, the same effects as the information analysis device described in the first aspect are exerted.

An information analysis method according to a seventh aspect of the present invention is performed by a computer, the method including:
a map information storing step of storing map information including facility information indicating an attribute of a facility for a plurality of facilities and parking lot information of the facility linked to the facility;
a vehicle travel information storing step of storing a vehicle travel information table including at least vehicle information, departure positional information, date/time information of departing, parking positional information, date/time information of parking and parked hours of a plurality of vehicles, the departure positional information being positional information of a vehicle departing, the parking positional information being positional information of the vehicle in a case of there being no change for at least a predetermined time in the positional information of the vehicle;
a parking position recording step of collecting and storing the parking positional information included in the vehicle travel information table, the parking positional information corresponding to parking lot information of the facility;
a visit pattern information creating step of creating visit pattern information related to the facility based on positional information of the vehicle included in a vehicle travel information table of a plurality of vehicles parked in a parking lot of the facility collected in the parking position recording step, and creating visit vehicle information related to the facility by cumulating vehicles parked in the parking lot of the facility for every vehicle information;
a visit pattern information storing step of storing the visit pattern information related to the facility and the visit vehicle information related to the facility by date/time and/or every day of the week;
a visit pattern change determining step of determining that both visit pattern information related to the facility stored in the visit pattern information storing step and visit vehicle information related to the facility have changed; and
a facility change information creating step of creating facility change information indicating a change in the facility information, when the visit pattern change determining step determines that both the visit pattern information and the visit vehicle information have changed.

According to the method of the seventh aspect, the same effects as the information analysis device described in the first aspect are exerted.

According to the present invention, it is possible to provide an information analysis device and an information analysis method which can detect a change in business form or usage mode of a facility without relying on manpower, by generating visit pattern information as visit pattern information to a facility and visit vehicle information, based on positional information transition data of the vehicle including vehicle information acquired from the vehicle as vehicle travel information, and determining a change in the visit pattern information and visit vehicle information.

### BRIEF DESCRIPTION OF THE DRAWINGS

FIG. 1 is a block diagram showing a basic configuration of an information analysis device which is an embodiment of the present invention;

FIG. 2A is a chart showing an example of first visit pattern information related to facilities according to an embodiment of the present invention;

FIG. 2B is a chart showing an example of change in the first visit pattern information related to facilities according to an embodiment of the present invention;

FIG. 3A is a chart showing an example of second visit pattern information related to a facility, created based on departure position information according to an embodiment of the present invention;

FIG. 3B is a chart showing an example of change in the second visit pattern information of a facility created based on departure positional information according to an embodiment of the present invention;

FIG. 4A is a chart showing an example of the third visit pattern information related to a facility created based on parking time information according to an embodiment of the present invention;

FIG. 4B is a chart showing an example of a change in third visit pattern information of a facility created based on parking time information according to an embodiment of the present invention;

FIG. 5A is a chart showing an example of visit vehicle information according to a vehicle number ratio calculated for every vehicle type of vehicle parked at a target facility created based on vehicle information according to an embodiment of the present invention;

FIG. 5B is a chart showing an example of a change in visit vehicle information according to a vehicle number ratio calculated for every vehicle type of vehicle parked at a facility according to an embodiment of the present invention;

FIG. 6 is a flowchart showing operation of determining whether there has been a change in usage mode of the facility relative to one determination target facility according to an embodiment of the present invention;

FIG. 7 is a block diagram showing a basic configuration according to a modified example of an information analysis device which is an embodiment of the present invention; and

FIG. 8 is a view showing an outline of a data structure of a positional information database related to a modified example of an information analysis device which is an embodiment of the present invention.

### DETAILED DESCRIPTION OF THE INVENTION

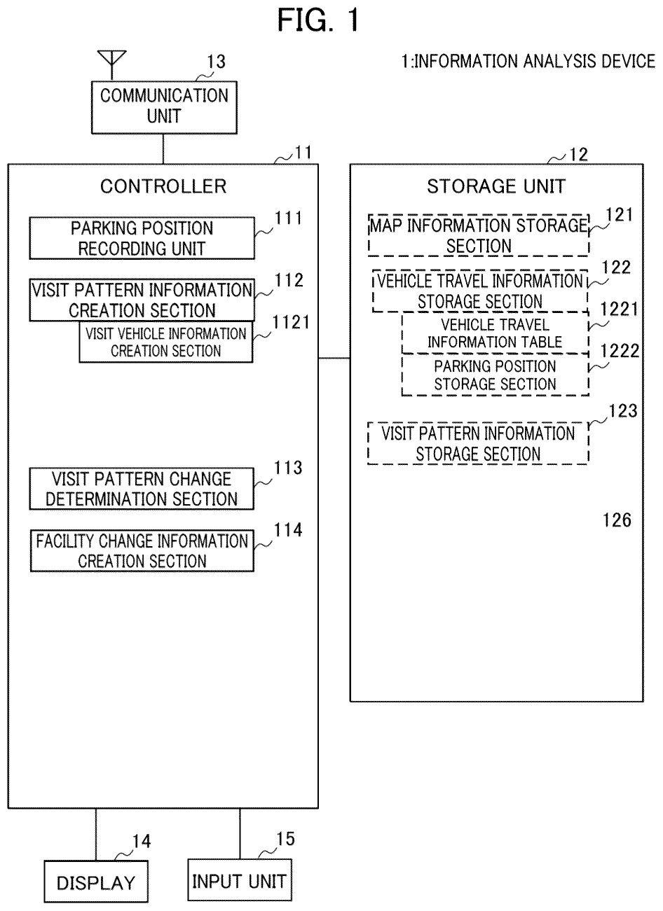

Hereinafter, a preferred embodiment of an information analysis device according to the present invention will be explained in detail while referencing the drawings. FIG. 1 shows the basic configuration of an information analysis device 1. An explanation will be provided for the functional block provided to the information analysis device 1 by referencing the block diagram of FIG. 1.

As shown in FIG. 1, the information analysis device 1 is configured to include a controller 11, a storage unit 12, a communication unit 13, a display unit 14 and an input unit 15.

The controller 11 is configured from an arithmetic processing unit such as a microprocessor, and performs control of each part constituting the information analysis device 1. Details of the controller 11 will be described later.

The storage unit 12 is configured by semiconductor memory or the like, and stores programs for control called firmware or operating system, various programs such as programs for performing parking positional information collection processing, visit pattern information creation processing, visit pattern change determination processing and facility change information creation processing, and further various information such as map information. Furthermore, the storage unit 12 includes a map information storage section 121, vehicle travel information storage section 122, and visit pattern information storage section 123. The map information storage section 121 stores map information including facility information indicating an attribute of each facility for a plurality of facilities, and parking lot information of the facility associated with this facility. The facility information, for example, includes identification information for facilities (facility ID), name of facility, facility classification related to a classification of facility (and/or genre), telephone number, address, business hours, positional information of facility, etc. The facility classification, for example, can be exemplified by shop classifications such as restaurant, supermarket, convenience store, sports gym, car dealership and hospital as examples. Furthermore, in the case of the facility classification being restaurant, as the category according to the many genres, it may be configured so as to include genres based on the contents of offered foods such as Japanese, Chinese, Western, Italian, French, coffee shops and genres based on viewpoints such as speed and convenience of fast food, drive through, ramen shop, and family restaurant. The genre can associate by combining several genres according to the contents thereof. For example, examples such as fast food are listed in Western food. It should be noted that facility classification (and genre), etc. are not limited thereto. In addition, the parking lot information of the facility includes positional information of this parking lot.

The vehicle travel information storage section 122 includes a vehicle travel information table 1221 and parking position storage section 1222.

The vehicle travel information table 1221 is a table storing at least vehicle information, departure positional information, departed time/date information, parking positional information, parking time/date information and parked hours of several vehicles collected within a predetermined area (for example, prefecture, town or the like) and predetermined time period (for example, 1 year or the like), and the departure positional information indicates positional information of the vehicle in the case of there being not change for at least a predetermined time in the positional information of the vehicle. It should be noted that the vehicle travel information table 1221, for example, is created based on positional information data (not shown) including moving transition information created using FCD (Floating Car Data) including the vehicle ID, positional information, time information, etc. received from a connected car. Creation of the vehicle travel information table 1221 is known technology to those skilled in the art as described in Patent Document 1, etc., for example. It should be noted that, from the viewpoint of personal information protection, the vehicle ID can be replaced with a random number in the vehicle travel information table 1221 or can be configured not to be included. In the present embodiment, the vehicle travel information table 1221 established a configuration appropriately downloaded from a server (omitted from illustration) connected to a communication network 60.

The parking position storage section 1222 is parking positional information of vehicles collected and recorded based on the vehicle travel information table 1221 by a parking position recording unit 111 described later, and the parking positional information stores records serving as a parking lot of the facility linked to the facility information included in the map information storage section 121 to be associated with the facility information. More specifically, it may be configured so that the parking position storage section 1222 stores the time/date at which the vehicle parked in the parking lot of the facility, parking hours, and departure positional information prior to parking of the vehicle in the parking lot of the facility, to correspond to the parking lot of the facility linked to the facility information included in the map information storage section 121. It should be noted that, as the departure positional information, it may be configured as most recent departure positional information traveling towards this parking lot, or home positional information of the vehicle. Furthermore, in the present embodiment, it may be configured so as to store the vehicle information of parked vehicles. Herein, vehicle information includes a model or vehicle type of the vehicle.

Vehicle model is a name common to general automobiles classified as having the same or similar structure, size, function, etc. of vehicle, and if body type, for example, is referred to as types such as sedan, compact/hatchback, minivan, van, light vehicle and truck. It should be noted that car brand, for example, is a unique name of vehicle such as “Step wagon (registered trademark)” and “Inspire (registered trademark)”. In addition, a certain degree of correlation is found between vehicle information and attributes of users of the vehicles. For example, there is a correlation such as a high proportion of users buying a minivan which can carry a large number of passengers as being families having a child of elementary school or junior high school age or younger. In addition, even for the same vehicle classification, there are cases of the buyers differing depending on the model, grade or exterior color. For example, even for the same model name, it is classified as for families, for men, etc. depending on the grade or exterior color. In addition, even for the vehicle type of sports type, there are correlations such as a large proportion of young persons having a small sports car indicating as being a sports car of small size, and many older high-income earners having a vehicle which is a large sport car indicating as being a large sports type. In the present embodiment, due to a certain degree of correlation being found between vehicle information and visitor demographic, it is configured so as to determine the possibility of usage mode of a facility having changed by determining a change in vehicle information, based on the parking position information parked at the facility.

The visit pattern information storage section 123 stores the visit pattern information created to correspond to the facility by the visit pattern information creation section 112, and the visit vehicle information, as described later. It is thereby possible to facility comparing the visit pattern information related to the facility created thus far and the visit vehicle information with the visit information related to this facility, for example.

The storage unit 12 was explained above; however, the facility information and map information stored in the map information storage section 121, the vehicle travel information table 1221, etc. included in the vehicle travel information storage section 122, etc. may be configured to be stored in advance in the storage unit 12, or may be configured to be appropriately downloaded as needed from a server (omitted from illustration) connected to the communication network 60. Furthermore, this information may be appropriately corrected according to an input of the user or the like. In the present embodiment, the vehicle travel information table 1221 establishes a configuration appropriately downloaded from a server (omitted from illustration) connected to the communication network 60.

The communication unit 13 has DSP or the like, and realizes wireless or wired communication with another device (for example, aforementioned server or the like) via the communication network 60, based on a standard of LTE (Long Term Evolution), 4G (4^{th} Generation), 5G (5^{th} Generation), or a standard such as Wi-Fi (registered trademark). It should be noted that the communication network 60 is realized by a network such as the Internet or telephone network, or a network combining these. In addition, LAN (Local Area Network) may be included in part of the network.

The display unit 14, for example, is configured by a display device such as a liquid crystal display, or organic electroluminescent panel. The display unit 14 receives an instruction from the controller 11 and displays an image. The input unit 15 is configured by an input device (omitted from illustration) such as physical switches called a ten key, or a touch panel provided on the display screen of the display unit 14.

Next, an explanation will be provided for the details of the controller 11. The controller 11 is configured from a CPU, RAM, ROM and a microprocessor having I/O, etc. The CPU executes each program read out from the ROM or storage unit 12, and reads out information from the RAM, ROM and storage unit 12 during execution thereof, performs writing of information in the RAM and storage unit 12, and performs transfer of signals with the communication unit 13. Then, the processing of the present embodiment is realized by hardware and software (program) cooperating in this way.

The controller 11 includes, as functional blocks, a parking position recording unit 111, visit pattern information creation section 112, visit pattern change determination section 113, and facility change information creation section 114. In addition, in the present embodiment, the visit pattern information creation section 112 further includes a visit vehicle information creation section 1121.

The parking position recording unit 111 collects parking positional information of a vehicle included in the vehicle travel information table 1221, in which the parking position is included in the parking lot of this facility linked to the facility information stored in the map information storage section 121, to be associated with this facility. More specifically, the parking position recording unit 111 also collects vehicle information, this parking positional information, together with parking time/date information (date, day of week, entry time, departure time, parking hours, etc.) and departure positional information of the vehicle departing towards this facility and the departing time/date information. It should be noted that the day of week may be configured to be calculated from calendar information (not shown) based on the date information. The parking position recording unit 111 may be configured so as to store vehicle information, the date/time information parked (date, day of week, entry time, departure time, parking hours, etc.). departure positional information of this vehicle departing towards this facility and date/time information of departing, which are collected together with the parking positional information, in the parking position storage section 1222 to be associated with every facility as one record (also referred to as “vehicle travel record to facility” for simplification hereinafter). It should be noted that, in the present embodiment, as the departure positional information corresponding to the parking positional information of the facility, although the most recent parking positional information of the vehicle departing towards the facility is used, it may be configured so as to use the home positional information of the vehicle as the departure positional information, as described later. It should be noted that, as the home positional information of the vehicle, for example, the positional information of the vehicle last parking of one day and positional information of first departing of one day, which are positional information of the largest proportion that are the same positional information may be established as the home positional information.

The facility which is the target for collecting the parking positional information by the parking position recording unit 111 may be configured to be designated by the user. More specifically, for example, by directly specifying the name of at least one facility, the parking position recording unit 111 may be configured so as to set the designated facility as the target for collection. In addition, by designating the facility classification, it may be configured so that the parking position recording unit 111 sets the facilities belonging to this facility classification as the target for collection. In addition, in the case of there being no designation from the user, it may be configured so as to set all of the facility information stored in the map information storage unit 121 as the default value as the target for collection. In this way, the parking position recording unit 111 can store the vehicle travel record to this facility for every facility serving as a target for collection in the parking information storage section 1222.

The visit pattern information creation section 112 calculates the visit pattern information to this facility and the visit vehicle information based on the vehicle travel record to this facility parked in the parking lot of this facility stored for every facility in the parking position storage section 1222, creates visit pattern information and visit vehicle information which is facility specific, and records in the visit pattern information storage section 123. In the present embodiment, the visit pattern information creation section 112 may be configured so as to include a visit vehicle information creation section 1121.

The visit time is an index in which a characteristic pattern can be seen according to the type of facility. For example, in an eating place such as a restaurant, there is a peak in the visit number at day time and night time normally, and there are also cases where the visit number differs on Saturdays, Sundays, national holidays, etc. compared to weekdays. In addition, in an eating place which is closed on Tuesdays, since there are no vehicles visiting other than vendors on Tuesday, there may be a characteristic to the visit number on specific days of the week. The visit pattern information creation section 112 may create a pattern of the visit time to this facility as the first visit pattern information, by accumulating the number of vehicles parked in every time slot in which parking was started (entered) at the facility for every facility stored in the parking position storage section 1222, and record in the visit pattern information storage section 123. More specifically, the visit pattern information creation section 112 may be configured so as to cumulate the number of vehicles parked for every time slot, by sorting the parking position information according to date/time. Herein, by time slot classifies the entry time into 1-hour units, for example, it may be set as a time slot of 9 AM to 10 AM, a time slot of 11 AM to 12 PM, a time slot of 12 PM to 1 PM, a time slot of 1 PM to 2 PM, . . . a time slot of 6 PM to 7 PM, a time slot of 7 PM to 8 PM, a time slot of 8 PM to 9 PM, etc. It should be noted that the time slots are not limited thereto. According to the classification of facility, etc., the time slots may be set based on any unit time. It should be noted that the visit pattern information creation section 112 may be further configured to calculate the pattern of visit time for holidays (Sundays and national holidays) and every day of the week of weekdays. It should be noted that, a case of a day of the week other than Sunday being a holiday which is a national holiday is handled as a holiday for this day. Hereinafter, unless otherwise state, “holiday (Sundays and national holidays) and day of week of weekdays” is simply referred to as “day of week”.

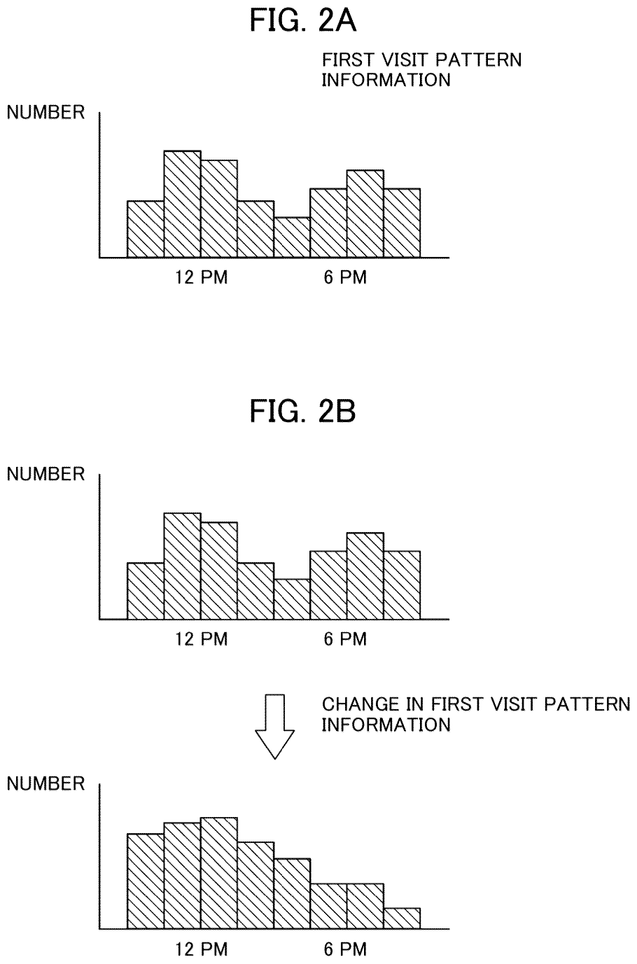

FIG. 2A is a chart showing an example of the first visit pattern information on any day of the week. The horizontal axis of the graph indicating the visit time trend shows the time slot (for example, 9 AM to 10 AM, 10 AM to 11 AM, etc.), and the vertical axis shows the average value in a predetermined time period of the number or the number percentage of vehicles parked in each time slot for every day of the week. FIG. 2B is a chart showing an example of the change in first visit pattern information related to a facility. As shown in FIG. 2B, in the case of there having been a change in the pattern of visit times of any calculated for every day of the week, for example, it is possible to estimate there is a high possibility of having change in the usage mode of this facility.

The visit pattern information creation section 112 may be configured so as to create second visit pattern information and third visit pattern information with a viewpoint differing from the first visit pattern information, based on the vehicle travel record to this facility parked in the parking lot of this facility stored for every facility in the parking position storage section 1222, and record these in the visit pattern information storage section 123. It should be noted that, even for the second visit pattern information and third visit pattern information, it may be configured so as to calculate by average value over a predetermined time period for every day of the week or the like, for example, similarly to the first visit pattern information.

In the present embodiment, three types of visit pattern information are exemplified; however, the visit pattern information is not limited thereto. It may be configured so as to create visit pattern information differing from the first visit pattern information, second visit pattern information and third visit pattern information from any viewpoint, based on the vehicle travel record to this facility parked in the parking lot of the target facility.

As the second visit pattern information, the visit pattern information creation section 112 can create the second visit pattern information differing from the first visit pattern information by plotting and accumulating departure position information visiting this facility for every predetermined mesh area created on the map, based on the departure positional information of the vehicle included in the “vehicle travel record to facility”. The visitor number from each mesh area to this facility can be regarded as expressing a sort of business region. In addition, for the second visit pattern information according to the visitor number information from each mesh area, it may be calculated according to the visitor number information in a predetermined time period (for example, from one month to three months, etc.). In addition, similarly to the first visit pattern, it may be configured to calculate according to the average value, etc. of a predetermined time period for every day of the week, for example. It should be noted that it may be configured so as to calculate the visitor number information from each mesh area for every time slot. It should be noted that it may be configured so as to calculate the second visit pattern information according to average value over a predetermined time period for every day of the week or the like, for example, similarly to the first visit pattern information.

A distance business region will be briefly explained before explaining the second visit pattern information. A distance business region is classified based on the radius distance from the facility, and is generally classified into walking business region, primary business region, secondary business region, and tertiary business region. Walking business region indicates a range which can be visited in a short time (for example, about 5 minutes on foot) unaffected by existing facilities and weather, the primary business region indicates a range which can be visited in an area of about 1 km radius (about 10 to 15 minutes on foot), the secondary business region indicates a range which can be visited in an area of about 3 km radius (10 to 15 minutes by bicycle), and the tertiary business region indicates a range which can be visited in about 30 to 40 minutes by transit or car, for example. It should be noted that, regarding the distance, the distance upon classifying the business regions differ depending on the business type and peripheral environment.

In the present embodiment, with the business region (for example, tertiary business region) of a range which can be visited by vehicle as the target, the visit pattern information creation section 112 creates the second visit pattern information indicating the relation between the target facility and departure positional information of the vehicle visiting the target facility, by dividing the map information including the tertiary business region of this target facility into a predetermined large grid cell region (section), and plotting and accumulating departure positional information of the vehicle included in this grid cell region for every grid cell region, and records this in the visit pattern information storage section 123. It should be noted that each grid cell region, for example, can be configured so as to be identified according to the central positional information (latitude and longitude) of this grid cell region. As the size of the grid cell region, it may be made into a section having a length of each side of 500 m. In addition, a larger section or smaller section than this may be established as the grid cell area. For the size of the grid cell area, for example, it may be configured so as to be set based on statistical information such as population, number of households, etc. included in the business region serving as the analysis target. In addition, for example, based on the calculation results of the second visit pattern information of the analysis target facility, for example, it may be configured so as to re-set the size of the grid cell area. It should be noted that it may be configured so that grid cell map information divided into grid cell areas is included in the map information stored in the map information storage section 121.

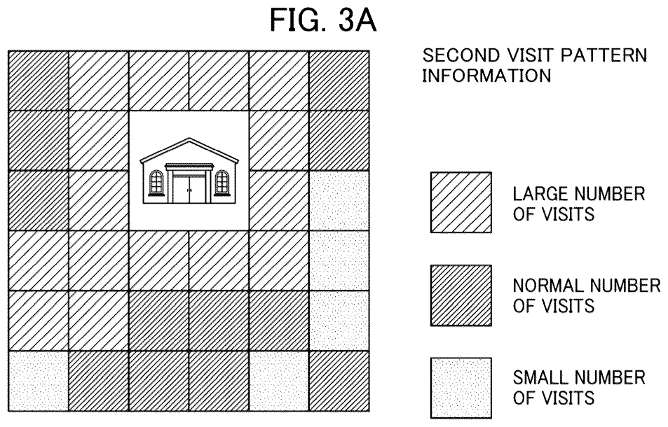

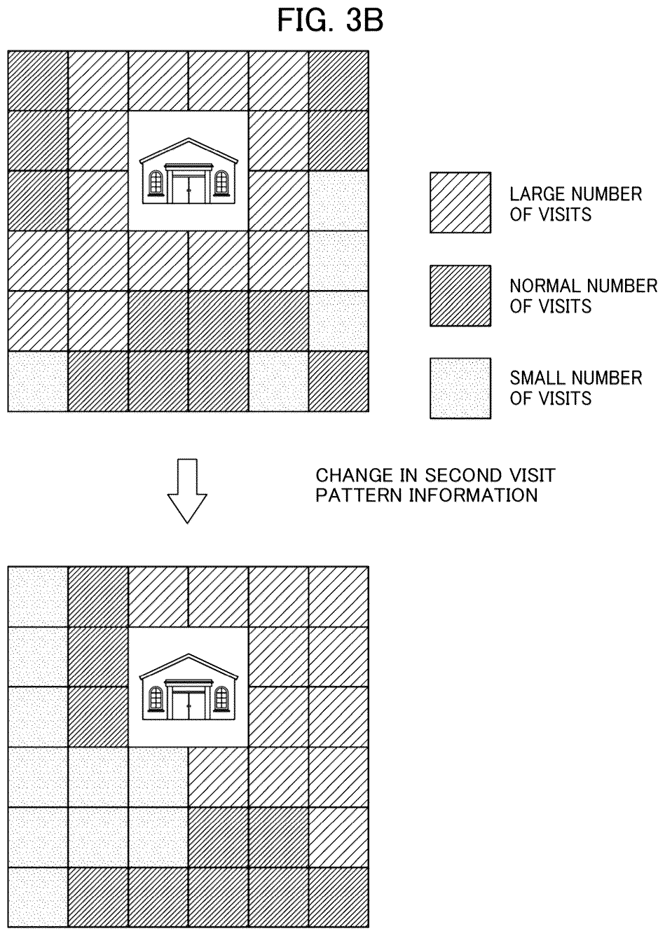

FIG. 3A is a view showing an example of the second visit pattern information related to the target facility created based on the departure positional information on any day of the week. As shown in FIG. 3A, for example, it may be represented by shading of the grid cell area according to the size of the total number of the departure positional information included in this grid cell area (for example, so that grid cell area of larger total number is darker, or grid cell area of larger total number is lighter). It should be noted that it may be configured so as to be represented by color in place of shading. FIG. 3B is a chart showing an example of the change in second visit pattern information created based on departure positional information on any day of the week. As shown in FIG. 3B, in the case of there being a change in the total number of departure positional information calculated for each day of the week, it is possible to estimate there being a high possibility of there being a change in the usage mode (e.g., business region) of this facility. The second visit pattern information was explained above based on the departure positional information.

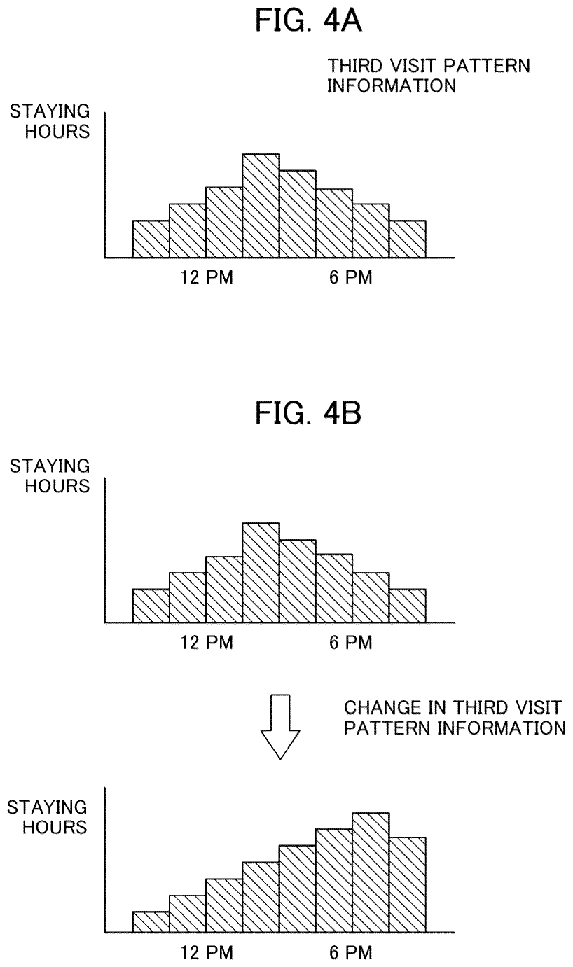

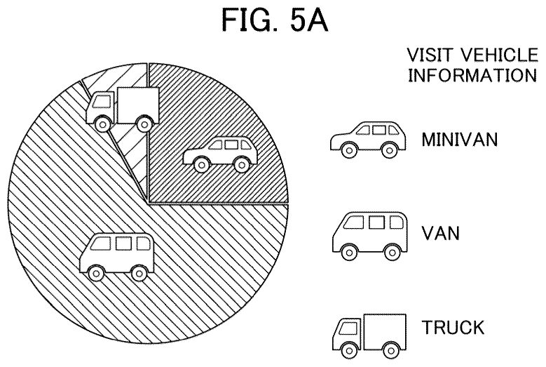

Next, third visit pattern information will be explained. The visit pattern information creation section 112 may be configured so as to create the third visit pattern information for a different viewpoint than the first visit pattern information and second visit pattern information, by cumulating the hours parked in the target facility (parked hours) for every time slot in which parking was started (entered). More specifically, the visit pattern information creation section 112 may be configured so as to cumulate the parking hours for which the vehicle parked in the parking lot of the facility collected by the parking position recording unit 111 for every time slot in which parking was started (entered) and create the third visit pattern information related to the facility, and record in the visit pattern information storage section 123. For example, when establishing as time slots of 1-hour units, in the case of the vehicle starting (entering) parking parked for 1 hour in the time slot from 12 PM to 1 PM, for example, the visit pattern information creation section 112 cumulates 1-hour parking hours in this time slot. The second visit pattern information created in this way can be regarded as an index representing a trend in staying hours of the visitor visiting in every entered time slot. FIG. 4A is a chart showing an example of the third visit pattern information related to the target facility created based on the parking hours. As shown in FIG. 4A, the horizontal axis of the graph indicates the time range (for example, 9 AM to 10 AM, 10 AM to 11 AM, etc.), and the vertical axis indicates the number of hours by cumulating the parked hours of the vehicles parked in every time range of a predetermined time period (or every day of the week). In the example shown in FIG. 4A, it is found that the time slot of daytime is a time slot having the largest total value of parked hours. In addition, FIG. 4B is a view showing an example of change in the third visit pattern information created based on the parked hours in the time slot in which parking was started. As shown in FIG. 4B, in the case of there being a change in total number of parked hours by visit time slot visiting the target facility on every day of the week, for example, it is possible to estimate that there is a high possibility of there being a change in the usage mode of this facility.

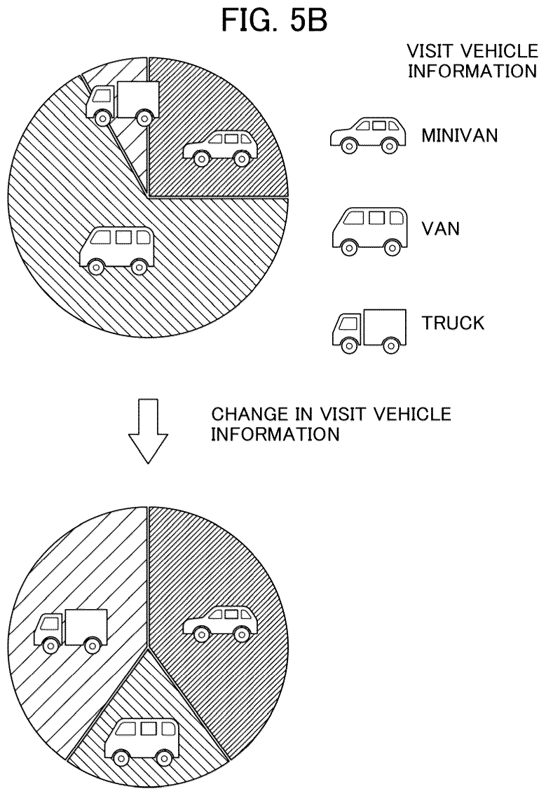

The visit vehicle information creation section 1121 calculates visit vehicle information to this facility, based on the vehicle travel record to this facility parked in the parking lot of this facility stored for every facility in the parking position storage section 1222, creates as visit vehicle information which is facility specific, and records in the visit pattern information storage unit 123. It should be noted that it may be configured so as to calculate the visit vehicle information according to average value over a predetermined time period for every day of the week or the like, for example, similarly to the first visit pattern information, second visit pattern information and third visit pattern information. In addition, similarly to the first visit pattern information and third visit pattern information, it may be configured so as to calculate visit vehicle information for every time slot as needed. The present embodiment explains a case of the visit vehicle information creation section 1121 calculating the visit vehicle information which is facility specific according to an average value over a predetermined time period for every day of the week or the like; however, it may be configured so as to calculate the visit vehicle information for every time slot. The visit vehicle information creation section 1121 creates the visit vehicle information by cumulating the number for every vehicle information of vehicles parked in the parking lot of a facility collected by the parking position recording unit 111. More specifically, the visit vehicle information creation section 1121 may be configured so as to cumulate the number of vehicles parked in this facility for every day of the week for each vehicle information, by sorting the parking positional information including the vehicle information according to time/date and vehicle information, corresponding to this facility. As described earlier, due to a certain degree of correlation being found between the vehicle information and attribute of users of this vehicle, the visit vehicle information can be regarded as an index representing the trend of one type of visit demographic. Hereinafter, an explanation is provided by exemplifying vehicle type as the vehicle information. It should be noted that the vehicle information is not limited to vehicle type. The vehicle model may be adopted as the vehicle information. FIG. 5A is visit vehicle information according to vehicle number ratio calculated for every vehicle type of vehicles parked in a target facility created based on the vehicle information. It should be noted that it may be configured as the vehicle number for every vehicle type instead of vehicle number ratio for every vehicle type; however, in the case regarding as an index representing the trend of visit demographic, due to the vehicle number ratio for every vehicle type being appropriate, the present embodiment exemplifies the vehicle number ratio for every vehicle type (hereinafter referred to as “vehicle type ratio”) In addition, it may be configured so as to calculate the vehicle type ratio for every time slot as the visit vehicle information; however, in the case of regarding as an index to see a trend in visit demographic of this facility, since it is considered that there is no problem in many cases even if calculating by day units, the present embodiment exemplifies by average value over a predetermined time period of values calculated for every day for the week or the like, for example. It should be noted that, in the case of facilities such that the ratio of vehicle types differ in time slot units, it may be configured so as to calculate the vehicle type ratio in time slot units. FIG. 5B is a chart showing an example of change in the visit vehicle information according to vehicle type ratio of vehicles parked at a facility. As shown in FIG. 5B, in the case of there having been a change in the vehicle type ratio of vehicles visiting the target facility, for example, it is possible to estimate that there is a high possibility of there having been a change in the usage mode of the facility.

The visit pattern change determination section 113 determines (detects) whether at least one, if not both, of visit pattern information related to a determination target facility stored in the visit pattern information storage section 123 and the visit vehicle information related to the determination target facility changed after a designated time period designated in advance. It should be noted the present embodiment exemplifies a form which compares an average value of a most recent month and an average value over a past three months from one month to four months prior for the change after the designated time period; however, it is not to be limited thereto. For example, it may compare the average over the most recent month and the average value over the same one month of the previous year (or preceding fiscal year). In addition, over one month and over three months are not limited thereto. Although they may be set to any time period, it is preferable to set as a time period of at least one month due to being an index for determining trends.

First, determining whether the first visit pattern information has changed will be explained. The visit pattern change determination section 113 calculates how much change by comparing the average value for the most recent one month of the number or number percentage of vehicles parked in each time slot for every day of the week (referred to as “most recent first visit pattern information”) with the average value for the past three months from one month to four months prior of the number or number percentage of vehicles parked in each time slot for every day of the week (referred to as “previous first visit pattern information”). As the calculation method of incremental difference, for example, the incremental difference can be represented by Formula 1 below, for example, when defining the number in an i^{th} time slot of the most recent first visit pattern information on every day of the week as most recent number (i) (i is time slot number), and defining the number in the i^{th} time slot of the previous first visit pattern information on every day of the week as previous number (i) It should be noted that the most recent number (i) and previous number (i) are calculated for every day of the week.

Σ_{1≤1≤n}|Most recent number (i)−previous number (i)| (Formula 1)

(n is number of time slots)
Then, by setting a first threshold in advance, the visit pattern change determination section 113 may be configured so as to determine as determining (detecting) change in the first visit pattern information in the case of the incremental difference on any day of the week calculated by Formula 1 exceeding the first threshold. It should be noted that a threshold may be set for every day of the week. In addition, the determination (detection) of change is not limited to the above-mentioned method. For example, it may be configured so as to calculate using a correlation coefficient represented by the product-moment coefficient of Pearson known to those skilled in the art, clustering represented by K-means clustering, or the like.

Next, determining whether the second visit pattern information has changed will be explained. The visit pattern change determination section 113 can calculate how much change by comparing the most recent second visit pattern information which is the average value of the most recent one month with the previous second visit pattern information which is the average value of the past three months from one month to four months prior. More specifically, in the case of defining a cluster of M×N number of grid cell areas set on the map as grid cell area (i,j) {1≤i≤M, 1≤j≤N}, and when defining the total value of the departure positional information from departing from the grid cell area (i,j) of the most recent second visit pattern information for every day of the week as most recent me(i,j), and defining the total value of the departure positional information from departing from the grid cell area (i,j) of the previous second visit pattern for every day of the week as previous me(i,j), the incremental difference can be represented by Formula 2 below, for example. It should be noted that it may be configured so that the most recent me(i,j) and previous me(i,j) are calculated for every day of the week as described before.

Σ_{1≤i≤M,1≤j≤N}|most recent me(i,j)−previous me(i,j)| (Formula 2)

Then, by setting the second threshold in advance, the visit pattern change determination section 113 may be configured so as to determine as determining (detecting) a change in the second visit pattern information in the case of the incremental difference of any day of the week calculated by Formula 2 exceeding the second threshold. It should be noted that a second threshold may be set for every day of the week. It should be noted that the determining (detecting) of change not being limited to the above-mentioned method is as described before.

Next, determining whether the third visit pattern information has changed will be explained. The visit pattern change determination section 113 calculates how much change by comparing the most recent third visit pattern information which is an average value over the most recent month with the previous third visit pattern information which is an average value over a past three months from one month to four months prior, similarly to the first visit information pattern. In the case of establishing the third visit pattern information as an average value of a predetermined time period for a total value of parked hours of vehicles parked (entered) in each time slot for every day of the week, it is possible to calculate the incremental difference similarly to the first visit pattern information. More specifically, the incremental difference can be represented by Formula 3 below, for example, when defining the parking hours total value of an i^{th} time slot of the most recent third visit pattern information for every day of the week as most recent parking hours (i) (i is time slot number), and defining the parking hours total value of an i^{th} time slot of the previous recent third visit pattern information for every day of the week as previous parking hours (i) It should be noted that the most recent parked hours (i) and previous parked hours (i) are calculated for every day of the week.

Σ_{1≤i≤n}|Most recent parked hours (i)−previous parked hours (i)| (Formula 3)

(n is number of time slots)
Then, by setting a third threshold in advance, the visit pattern change determination section 113 may be configured so as to determine as determining (detecting) a change in the third visit pattern information, in the case of the incremental difference on any day of the week calculated by Formula 2 exceeding the third threshold. It should be noted that a third threshold is set for every day of the week. It should be noted that the determining (detecting) of change not being limited to the above method is as described earlier. Determining the presence/absence of change in the first visit pattern information, second visit pattern information and third visit pattern information by the visit pattern change determination section 113 has been explained above.

Next, determining the presence/absence of change in the visit vehicle information by the visit pattern change determination section 113 will be explained. The visit pattern change determination section 113 can calculate how much change by comparing the vehicle type ratio which is an average value over the most recent month with the previous vehicle type ratio which is an average value over a past three months from one month to four months prior, similarly to as described above. More specifically, in the case of there being M-number of vehicle types, the incremental difference can be represented by Formula 4 below, for example, when defining a set of M-number of vehicle types as vehicle type i {1≤i≤M}, defining the vehicle type ratio (i) of the most recent_vehicle type (i) for every day of the week and most recent_vehicle type ratio (i), and defining the vehicle type ratio (i) of the previous vehicle type (i) for every day of the week as previous_vehicle type ratio (i). It should be noted that it may be configured so that the most recent_vehicle type ratio (i) and previous_vehicle type ratio (i) are calculated for every day of the week as described above.

Σ_{1≤i≤M}|Most recent_vehicle type ratio (i)−previous_vehicle type ratio (i)| (Formula 4)

Then, by setting a fourth threshold in advance, it may be configured so that the visit pattern change determination section 113 determines as determining (detecting) a change in the visit vehicle information in the case of the incremental difference on any day of the week calculated by Formula 4 exceeding the fourth threshold. It should be noted that a fourth threshold may be set for every day of the week. It should be noted that the determining (detecting) of change not being limited to the above method is as described earlier.

The facility change information creation section 114 may be configured so as to create facility change information indicating a change in the facility information, when determined (detected) that both the visit vehicle information related to the target facility for determination and at least one visit pattern information have both changed according to the visit pattern change determination section 113, and then output via the display unit 14, for example. In addition, in the case of not determining (detecting) change, it may be configured so as to create information that does not change this facility information, and output this via the display 14, for example. Herein, as the at least one visit pattern information, any of the first visit pattern information, second visit pattern information and third visit pattern information may be used, for example. It should be noted that the facility change information creation section 114 can detect that there is a high possibility of the business form or usage mode of the facility having changed; however, it will not specifically detect to what that the usage mode of the target facility changed. As described above, following the facility change information, the user can immediately confirm the changed contents of the business form or usage mode of the target facility by a field study or the like. The configuration of each functional block of the information analysis device 1 exemplified as the present embodiment was explained above.

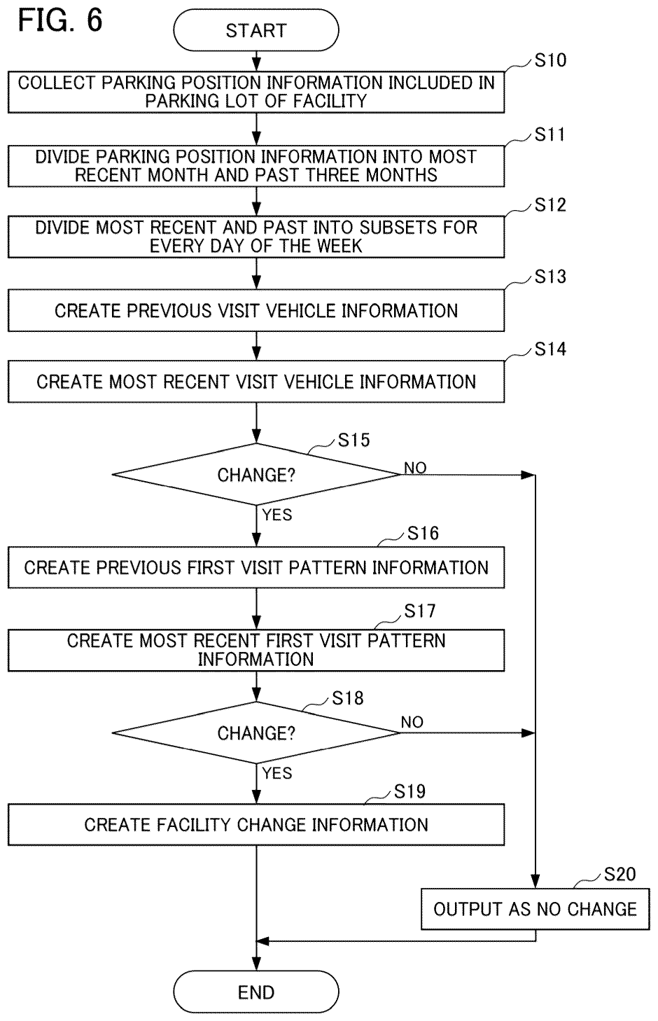

Next, operation of the present embodiment will be explained by referencing the flowchart illustrated in FIG. 6. FIG. 6 is a flowchart showing operation of determining whether there has been a change in the usage mode of this facility by determining (detecting) a change in the visit vehicle information and visit pattern information, relative to one determination target facility designated from the user. In addition, the determination of a change in the visit vehicle information and visit pattern information exemplifies processing of determining a change in visit pattern information by comparing between the average value for a most recent month of each value calculated for every day of the week, and the average value for the past three months from one month to four months prior for each value calculated for every day of the week. It should be noted that, although the first visit pattern information is exemplified as the visit pattern information, it is not limited thereto. Any visit pattern information may be adopted. In the case of there being a plurality of determination target facilities, a determination target facility is selected one by one from the collection of the plurality of determination target facilities, it is determined whether there has been a change in the usage mode of this facility by the flowchart illustrated in FIG. 6, and when the determination processing related to this facility is ended, the remaining determination target facilities are selected one by one and the same processing is performed, and by repeatedly performing this processing on all designated facilities, it is possible to determine whether there has been a change in usage mode of each facility.

When referencing FIG. 6, in Step S10, the information analysis device 1 (parking position recording unit 111), for example, collects the parking positional information including a vehicle classification of the vehicle stored in the vehicle travel information table 1221 of the most recent one month and a past three months from one month to four months prior, which is parking positional information in which the parking position is included in the parking lot of this facility linked to the facility information stored in the map information storage section 121, to be associated with this facility.

In Step S11, the information analysis device 1 (parking position recording unit 111) divides a set made by collecting in Step S10 into a set of parking positional information stored over the most recent one month and a set of the parking positional information stored over a past three months from one month to four months prior.

In Step S12, the information analysis device 1 (parking position recording unit 111) stores each set divided in Step S11 to be separate in subsets for every day of the week, based on the parking time/date information. Hereinafter, the subset for every day of the week of the set of parking positional information stored over the most recent one month is referred to as “most recent day of week parking position set”, and the subset for every day of the week of the collection of parking positional information stored over a past three months from one month to four months prior is referred to as “previous day of week parking position set”. The “most recent day of week parking position set” and “previous day of week parking position set” are configured from seven subsets for days of the week of holiday, Monday, Tuesday, Wednesday, Thursday, Friday and Saturday.

In Step S13, the information analysis device 1 (visit vehicle information creation section 1121) creates the visit vehicle pattern information of each day of the week over the past three months of one month to four months prior based on the previous_day of week parking position set.

In Step S14, the information analysis device 1 (visit pattern information creation section 112) creates visit vehicle information of each day of the week over the most recent month based on the most recent_day of week parking position set.

In Step S15, the information analysis device 1 (visit pattern change determination section 113) determines whether there has been a change in the visit vehicle information of at least any day of the week. In the case of a change being determined (case of YES), the processing advances to Step S16. In the case of a change not being determined (case of NO), the processing advances to Step S20.

In Step S16, the information analysis device 1 (visit pattern information creation section (112) creates first visit pattern information for each day of the week over a past three months from one month to four months prior, based on the previous_day of week parking position set.

In Step S17, the information analysis device 1 (visit pattern information creation section (112) creates first visit pattern information for each day of the week over the most recent one month, based on the most recent day of week parking position set.

In Step S18, the information analysis device 1 (visit pattern change determination section 113) determines whether there has been a change in the first visit pattern information for at least any day of the week. In the case of a change being determined (case of YES), the processing advances to Step S19. In the case of a change not being determined (case of NO), the processing advances to Step S20.

In Step S19, the information analysis device 1 (facility change information creation section 114) creates facility change information indicating the change in this facility information with there being a change in both the visit vehicle information and first visit pattern information, outputs this via the display unit 14, for example, and then ends processing related to this facility.

In Step S20, the information analysis device 1 (facility change information creation section 114) makes no change in the usage mode of this facility and outputs as “no change in usage mode of facility” via the display unit 14, for example, and then ends processing related to this facility.

Additional explanation will be provided for the processing of Step S15. In the above operation flow, in the case of a change not being determined (detected) in the visit vehicle information, it was ended without calculating the first visit pattern information. It is thereby possible to omit the time, etc. related to determination processing. For example, in the case of there being a plurality of determination target facilities, or in the case of setting all facility information stored in the map information storage section 121 as a determination target facility, it effectively acts in the shortening of the processing time. It should be noted that, as the processing flow upon calculating both the visit vehicle information and first visit pattern information, it may be configured so as to determine whether there has been a change in the visit vehicle information and first visit pattern information.

The above has explained the operation of the information analysis device 1 determining whether there has been a change in the usage mode of the facility, by generating the visit vehicle information and visit pattern information as visit information to the determination target facility, and determining a change in the two sets of visit information. From the above, the information analysis device 1 makes it possible to detect a change in usage mode of the facility without relying on man power, by detecting a change in the usage mode of the determination target facility without relying on man power.

Each of the respective devices can be realized by hardware, software or a combination of these. In addition, the navigation method which can be performed by each of the respective devices included in the above-mentioned navigation system cooperating can also be realized by hardware, software or a combination of these. Herein, realized by software indicates being realized by a computer read out and executing programs.

The program is stored using various types of non-transitory computer readable media, and can be supplied to a computer. Non-transitory computer readable media includes various types of tangible storage media. Examples of non-transitory computer readable media include magnetic media (for example, flexible disk, magnetic tape, hard disk drive), magneto-optical recording media (for example, magneto-optical disk), CD-ROM (Read Only Memory), CD-R, CD-R/W, and semiconductor memory (for example, mask ROM, PROM (Programmable ROM), EPROM (Erasable PROM), flash ROM, RAM (random access memory)). In addition, the program may be supplied to the computer by various types of transitory computer readable media. Examples of the transitory computer readable media include electrical signals, optical signals, and radio waves. Transitory computer readable media can supply programs to the computer via wired communication paths such as electric wires and optical fiber, or wireless communication paths.

The aforementioned embodiment is a preferred embodiment of the present invention; however, it is not to limit the scope of the present invention to only the above embodiment, and implementation in modes arrived at by conducting various modifications in a range not departing from the gist of the present invention is possible.

### Modified Example 1

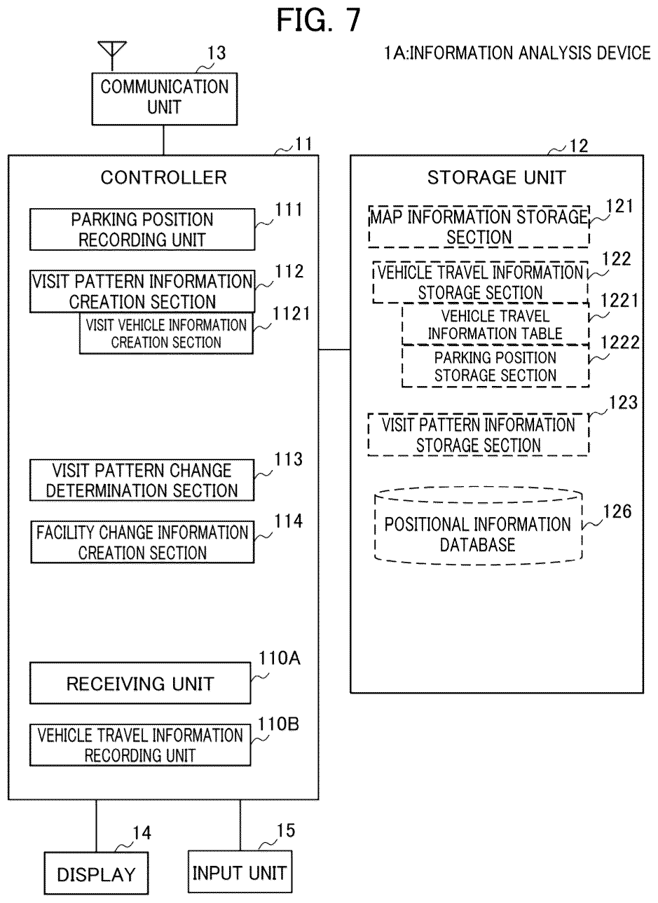

FIG. 7 shows a functional block diagram related to a modified example of an information analysis device. In the aforementioned embodiment, the vehicle travel information table 1221 was configured to be appropriately downloaded from a server (omitted from illustration) connected to the communication network 60; however, as shown in FIG. 7, the information analysis device 1A may be configured so as to include a receiving unit 110A and vehicle travel information recording unit 110B, in addition to the parking position recording unit 111, visit pattern information creation section 112, visit pattern change determination section 113 and facility change information creation section 114, as functional blocks of the controller 11. It may be configured so that the receiving unit 110A receives identification information of the vehicle, vehicle information, positional information, time information, etc. from each vehicle via the communication unit 13, appropriately creates and updates the positional information database 126 representing the moving transition of each vehicle based on the identification information, vehicle information, positional information, time information, etc. received from each vehicle, the vehicle travel information recording unit 110B determines that the vehicle parked in the case of there being no change for at least a predetermined time in the positional information based on the positional information database 126, and stores the positional information determined as the vehicle having parked in the storage unit 12 as parking positional information as a vehicle travel information table 1221. It should be noted that, as mentioned above, it is possible to configure so that the vehicle ID is not included in the vehicle travel information table 1221 from the viewpoint of personal information protection. The receiving unit 110A and vehicle travel information recording unit 110B will be explained briefly hereinafter.

The receiving unit 110A receives the successive positional information from the plurality of vehicles together with time information. More specifically, the receiving unit 110A is a portion which updates the positional information database 126 based on the vehicle information, successive position information and vehicle ID (also referred to as moving body ID), received from the vehicle (also referred to as moving body) via the communication unit 13.

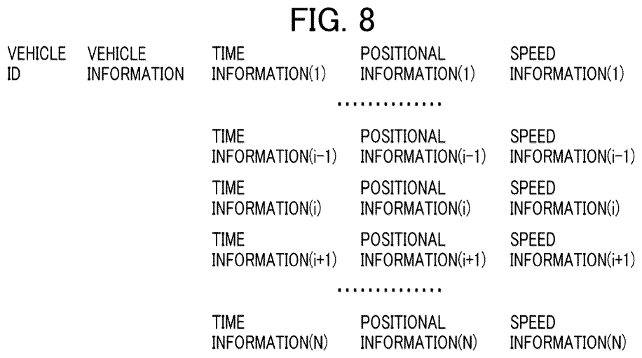

The positional information database 126 may be configured so as to store positional information including vehicle information of a traveling vehicle over at least the most recent one year, for example. In addition, the positional information database 126 may be configured so as to store positional information including vehicle information of the traveling vehicle in prefecture units, regional units or the like, for example. An example of the data structure of the positional information database 126 will be explained by referencing FIG. 8. As shown in FIG. 8, the positional information database 126 may be configured so as to store, for every vehicle, the “speed information”, in addition to the “vehicle ID”, “vehicle information”, “successive positional information from the vehicle and time information” received by the receiving unit 110A.

The “vehicle ID” in the positional information database 126 is information for identifying the car navigation device or portable terminal which are the senders of the positional information, etc. of the vehicle equipped with these, as mentioned above. The “vehicle information” in the positional information database 126 is information including the vehicle type or model of vehicle as described above. The “positional information” in the positional information database 126 is all of the successive positional information received from the vehicle since transmission of positional information, etc. was started until now. The “time information” is time information from performing positioning of the positional information. From all of this successive positional information and time information, it becomes possible to determine vehicle parking information including the parking position, parking time/date, etc. It should be noted that, in the case of the speed information being sent together with the positional information from the vehicle, the received speed information is stored to be linked with the time information and positional information.

The vehicle travel information recording unit 110B determines that the vehicle has parked in the case of being determined that there is no change for at least a predetermined time in the vehicle positional information, based on the positional information database 126. In addition, the vehicle travel information recording unit 110B, in the case of determining that the vehicle parked, calculates this time/date, day of the week, parking time, movement time and parking hours of the vehicle 50. The vehicle travel information recording unit 110B stores, in the vehicle travel information table 1221, with the positional information determined as the vehicle 50 having parked as the parking position of this vehicle, together with the vehicle information. As mentioned above, it is possible to configure so that the vehicle ID is not included in the vehicle travel information table 1221 from the viewpoint of personal information protection. The vehicle travel information recording unit 110B stores together at least the vehicle information of each vehicle, departure positional information, departure time/date information, parking positional information, parked time/date information, parking hours, etc. in the vehicle travel information table 1221. Herein, the parking time indicates the time (entry time) of the moving object parking at this parking position, and the movement time indicates the time when the moving object moved (departing or leaving garage) from this parking position. The vehicle travel information table 1221 may be configured so as to record and cumulate vehicle parking information by prefecture or regional units, with one year as the collection time period, for example.

More specifically, for example, in the case of receiving positional information since transmission of positional information, etc. was once started to last, and there not being transmission of positional information of a predetermined time, the vehicle travel information recording unit 110B may determine that the position corresponding to this last received positional information is the parking position. In this case, the vehicle travel information recording unit 110B may calculate a predetermined time for which there was no transmission of positional information as the parking hours of the vehicle. In addition, in a case such that the position corresponding to other transmitted positional information not changing for at least a fixed time, it may be determined that this position is the parked position. In this case, the vehicle travel information recording unit 110B may calculate the hours for which the position did not change as the parked hours of the vehicle. In addition, in the case of the interval between each time at which the positional information adjacent to the successive positional information received from the vehicle was measured exceeding a first time set in advance or being greater than or equal to, and falling below a second time set in advance or being equal to or less than, and any of the speed information in this adjacent positional information falling below a predetermined speed V₀ set in advance or being equal to or less than, the vehicle travel information recording unit 110B may determine that the vehicle stopped. In this case, the vehicle travel information recording unit 110B may calculate the interval between each time at which this adjacent positional information was measured as the parking hours of the vehicle. Herein, a predetermined speed V₀ may be established as a speed degree upon stopping at the parking lot, for example. In addition, it may be established as 0 km/h. It may be set according to the characteristic of every vehicle (characteristic during driving of the driver). By configuring in the above way, for example, even if the device is a device which cannot transmit positional information during ignition ON and/or during ignition OFF, it is possible to specify information expected as vehicle stop. It should be noted that in the case of transmission of positional information of the vehicle stopping due to ignition OFF of the vehicle as in the car navigation device in current engined vehicles, the current position transmitted immediately prior to reception of positional information of the vehicle stopping may be established as the parked position. In this case, the vehicle travel information recording unit 110B may calculate the time from when transmission of positional information of the vehicle stopped until transmission of positional information of this vehicle is started next as the parked hours of this vehicle. Similarly, in the case of the vehicle starting transmission of positional information of the vehicle due to ignition ON as in a car navigation device in current engine vehicles, for example, the current position at which reception of positional information of the vehicle started may be established as the parked position. In this case, the vehicle travel information recording unit 110B may calculate the time difference from the time at which transmission of the positional information of this vehicle stopped before starting reception of the positional information of the vehicle, as the parked hours of this vehicle. In addition, even in the case of the vehicle stopping as in an electric vehicle, for example, when it is possible to transmit stop signal information, it may establish the current position indicated by the stop signal or the most recent positional information of the positional information of the vehicle as the parked position. In this case, the vehicle travel information recording unit 110B may calculate the hours since receiving stop signal information until receiving the next startup signal information or positional information as the parked hours of this vehicle. Similarly, in the case of the vehicle being able to transmit startup signal information during startup of the vehicle as in an electric vehicle, for example, the current position indicated by the startup signal may be established as the parked position. In this case, the vehicle travel information recording unit 110B may calculate the time difference from the time when receiving the stop signal information or last position signal from this vehicle before receiving trajectory signal information as the parked hours of this vehicle.

### Modified Example 2

In the aforementioned embodiment, although realizing the information analysis device 1 by way of one server or the like was explained, it may be established as a distributed processing system which distributes each function of the information analysis device 1 to a plurality of servers as appropriate. In addition, it may realize each function of the information analysis device 1 using a virtual server function or the like on the cloud.

### EXPLANATION OF REFERENCE NUMERALS

1 information analysis device
1A information analysis device
11 controller
110A receiving unit
110B vehicle travel information recording unit
112 visit pattern information creation section
1121 visit vehicle information creation section
113 visit pattern change determination section
114 facility change information creation section
12 storage unit
121 map information storage section
122 vehicle travel information storage section
1221 vehicle travel information table
1222 parking position storage section
123 visit pattern information storage section
126 positional information database
13 communication unit
14 display unit
15 input unit
60 communication network

What is claimed is:

1. An information analysis device comprising:
a map information storage unit which stores map information including facility information indicating an attribute of a facility for a plurality of facilities and parking lot information of the facility linked to the facility;
a vehicle travel information storage unit which stores a vehicle travel information table including at least vehicle information, departure positional information, date/time information of departing, parking positional information, date/time information of parking and parked hours of a plurality of vehicles, the departure positional information being positional information of a vehicle departing, the parking positional information being positional information of the vehicle in a case of there being no change for at least a predetermined time in the positional information of the vehicle;
a parking position recording unit which collects and stores the parking positional information included in the vehicle travel information table, the parking positional information corresponding to parking lot information of the facility;
a visit pattern information creation section which visit pattern information related to the facility based on positional information of the vehicle included in a vehicle travel information table of a plurality of vehicles parked in a parking lot of the facility collected by the parking position recording unit, and creates visit vehicle information related to the facility by cumulating vehicles parked in the parking lot of the facility for every vehicle information;
a visit pattern information storage section which stores the visit pattern information related to the facility and the visit vehicle information related to the facility by date/time and/or every day of the week;
a visit pattern change determination section which determines that both visit pattern information related to the facility stored in the visit pattern information storage section and visit vehicle information related to the facility have changed after a first predetermined time period set in advance; and
a facility change information creation section which creates facility change information indicating a change in the facility information, when the visit pattern change determination section determines that both the visit pattern information and the visit vehicle information have changed.

2. The information analysis device according to claim 1, further comprising a receiving unit which receives vehicle information indicating an attribute of a vehicle from a plurality of vehicles, and successive positional information of the vehicle as vehicle travel information together with time information; and
a vehicle travel information recording unit which creates a vehicle travel information table including at least vehicle information, departure positional information, date/time information of departing, parking positional information, date/time information of parking and parked hours of a plurality of vehicles, the departure positional information being positional information of a vehicle departing, the parking positional information being positional information of the vehicle in a case of there being no change for at least a predetermined time in the positional information of the vehicle.

3. The information analysis device according to claim 1, wherein the visit pattern information creation section creates visit pattern information of the facility by cumulating a number of vehicles for every time slot in which parking of the vehicle was started, based on a vehicle travel information table of vehicles parked in a parking lot of the facility collected by the parking position recording unit.

4. The information analysis device according to claim 1, wherein the visit pattern information creation section creates the visit pattern information as summary value information of departure positional information for every grid cell, obtained by plotting and cumulating the departure positional information of the vehicle in every predetermined grid cell created in the map information, based on a vehicle travel information table of vehicles parked in a parking lot of the facility collected by the parking position recording unit.

5. The information analysis device according to claim 1, wherein the visit pattern information creation section creates visit pattern information related to the facility by cumulating, for every time slot in which parking was started, parked hours of the vehicle parked at each of the parking lots based on a vehicle travel information table of the vehicle parked in a parking lot of the facility collected by the parking position recording unit.

6. The information analysis device according to claim 1, wherein the vehicle information includes any information of a vehicle model or vehicle type of the vehicle.

7. An information analysis method performed by a computer, the method comprising:
a map information storing step of storing map information including facility information indicating an attribute of a facility for a plurality of facilities and parking lot information of the facility linked to the facility;
a vehicle travel information storing step of storing a vehicle travel information table including at least departure positional information, date/time information of departing, parking positional information, date/time information of parking and parked hours of a plurality of vehicles, the departure positional information being positional information of a vehicle departing, the parking positional information being positional information of the vehicle in a case of there being no change for at least a predetermined time in the positional information of the vehicle;
a parking position recording step of collecting and storing the parking positional information included in the vehicle travel information table, the parking positional information corresponding to parking lot information of the facility;
a visit pattern information creating step of creating visit pattern information related to the facility based on positional information of the vehicle included in a vehicle travel information table of a plurality of vehicles parked in a parking lot of the facility collected in the parking position recording step, and creating visit vehicle information related to the facility by cumulating vehicles parked in the parking lot of the facility for every vehicle information;
a visit pattern information storing step of storing the visit pattern information related to the facility and the visit vehicle information related to the facility by date/time and/or every day of the week;
a visit pattern change determining step of determining that both visit pattern information related to the facility stored in the visit pattern information storing step and visit vehicle information related to the facility have changed after a first predetermined time period set in advance; and
a facility change information creating step of creating facility change information indicating a change in the facility information, when the visit pattern change determining step determines that both the visit pattern information and the visit vehicle information have changed.
